(19) United States
(12) Patent Application Publication
(10) Pub. No.: US 2026/0045059 A1
(43) Pub. Date: Feb. 12, 2026

(54) AUTO REPLY DEVICE, AUTO REPLY METHOD, AND COMPUTER PROGRAM FOR AUTO REPLY

(71) Applicant: TOYOTA JIDOSHA KABUSHIKI KAISHA, Toyota-shi (JP)

(72) Inventors: Yasufumi KAWANO, Tokyo-to (JP); Yuta TSUZUKI, Tokyo-to (JP)

(73) Assignee: TOYOTA JIDOSHA KABUSHIKI KAISHA, Toyota-shi (JP)

(21) Appl. No.: 19/268,348

(22) Filed: Jul. 14, 2025

(30) Foreign Application Priority Data
Aug. 7, 2024 (JP) 2024-130988

(51) Int. Cl. G06V 10/25; G06V 10/82; G06V 10/94; G06V 20/56; G06V 20/59; G06V 40/10

(52) U.S. Cl. CPC G06V 10/25; G06V 10/945; G06V 10/82; G06V 20/56; G06V 20/59; G06V 40/10

(57) ABSTRACT

An auto reply device includes a processor configured to pre-process an image to extract a predetermined region in the image, depending on a question, and generate an answer to the question by inputting a pre-processed image and the question into a generation model that has been trained to generate the answer.

### FIELD

The present invention relates to an auto reply device that automatically replies to a user's question, an auto reply method, and a computer program for auto reply.

### BACKGROUND

A known generation model (vision language model, hereafter “VLM”) generates an answer to a question related to an image by referring to the image upon input of the image and the question given as text. A proposed technique draws the VLM's attention to an object of interest by drawing a red circle around the object in an image to be inputted into the VLM (see Aleksandar Shtedritski et al., “What does CLIP know about a red circle? Visual prompt engineering for VLMs,” 2023 IEEE/CVF International Conference on Computer Vision (ICCV)), https://dx.doi.org/10.1109/ICCV51070.2023.01101).

### SUMMARY

Of individual objects represented in an image, an object related to a question to be inputted into a VLM varies, depending on the question. For this reason, the above-described technique requires drawing a red circle at each question, which is very time-consuming.

It is an object of the present invention to provide an auto reply device that can generate an appropriate answer to a question about a particular object represented in an image with reduced man-hours.

According to an embodiment, an auto reply device is provided. The auto reply device includes a processor configured to: pre-process an image to extract a predetermined region in the image, depending on a question, and generate an answer to the question by inputting a pre-processed image and the question into a generation model that has been trained to generate the answer.

In an embodiment, the processor is further configured to recognize at least one predetermined object represented in the image; when the question includes identifying information of one of the at least one predetermined object, the processor determines an object region representing an object identified by the identifying information among the at least one predetermined object in the image as the predetermined region.

In an embodiment, when the question does not include identifying information of any of the at least one object, the processor determines the entire image as the predetermined region.

In an embodiment, the processor identifies a region to which a person related to the question is paying attention in the image, based on the posture of the person, and determines the identified region as the predetermined region.

According to another embodiment, an auto reply method is provided. The auto reply method includes pre-processing an image to extract a predetermined region in the image, depending on a question, and generating an answer to the question by inputting a pre-processed image and the question into a generation model that has been trained to generate the answer.

According to still another embodiment, a non-transitory recording medium that stores a computer program for auto reply is provided. The computer program includes instructions causing a computer to execute a process including pre-processing an image to extract a predetermined region in the image, depending on a question, and generating an answer to the question by inputting a pre-processed image and the question into a generation model that has been trained to generate the answer.

The auto reply device of the present disclosure has an advantageous effect of being able to generate an appropriate answer to a question about a particular object represented in an image with reduced man-hours.

### BRIEF DESCRIPTION OF DRAWINGS

FIG. 1 schematically illustrates the configuration of a vehicle equipped with an auto reply device.

FIG. 2 illustrates the hardware configuration of the auto reply device.

FIG. 3 is a functional block diagram of a processor of the auto reply device.

FIG. 4 is a diagram for explaining input and output of an answer generation model of the embodiment.

FIG. 5 is an operation flowchart of the auto reply device.

### DESCRIPTION OF EMBODIMENTS

An auto reply device, an auto reply method executed by the auto reply device, and a computer program for auto reply will now be described with reference to the attached drawings. The auto reply device inputs a pre-processed image obtained by pre-processing an image to extract a predetermined region in the image, depending on a question, and the question into a generation model that has been trained to generate an answer to the question, thereby generating an answer.

The following describes an embodiment in which an answer to a question from an occupant of a vehicle is automatically generated by an auto reply device being mounted on the vehicle.

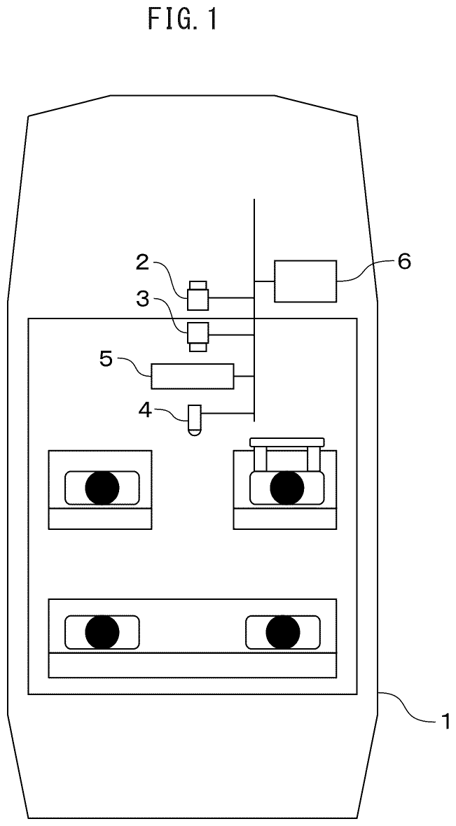

FIG. 1 schematically illustrates the configuration of a vehicle equipped with an auto reply device. In the present embodiment, the vehicle 1 includes an exterior camera 2, an interior camera 3, at least one microphone 4, a notification device 5, and an auto reply device 6. The exterior camera 2, the interior camera 3, the microphone 4, and the notification device 5 are communicably connected to the auto reply device 6.

The exterior camera 2, which is an example of an exterior imaging unit, is mounted in the interior of the vehicle 1 and oriented to a predetermined region around the vehicle 1 (e.g., a region in front of the vehicle 1) so that the predetermined region can be captured. Every predetermined capturing period, the exterior camera 2 generates an image representing the predetermined region and outputs the generated image to the auto reply device 6. An image generated by the exterior camera 2 will be referred to as an “exterior image,”below.

The interior camera 3, which is an example of an interior imaging unit, is mounted near the top of the windshield and oriented to the vehicle interior so that all the occupants in the vehicle 1 are included in a region to be captured by the camera. Every predetermined capturing period, the interior camera 3 generates an image representing the region to be captured and outputs the generated image to the auto reply device 6. An image generated by the interior camera 3 will be referred to as an “interior image,”below.

The at least one microphone 4 picks up a voice of one of the occupants in the vehicle 1 and outputs a voice signal representing the voice. To achieve this, each microphone 4 is mounted in the interior of the vehicle 1. Multiple microphones 4 may be arrayed, or mounted near respective seats in the interior of the vehicle 1.

The notification device 5 is provided in the interior of the vehicle 1 and notifies an occupant of an answer generated by the auto reply device 6. To achieve this, the notification device 5 includes, for example, at least one of a speaker or a display. When an answer signal representing an answer to an occupant is received from the auto reply device 6, the notification device 5 notifies the occupant of the answer by a voice from the speaker or by displaying a message, an image, or a video on the display.

The auto reply device 6 generates an answer to a question from an occupant of the vehicle 1, and notifies the generated answer to the occupant of the vehicle 1 via the notification device 5.

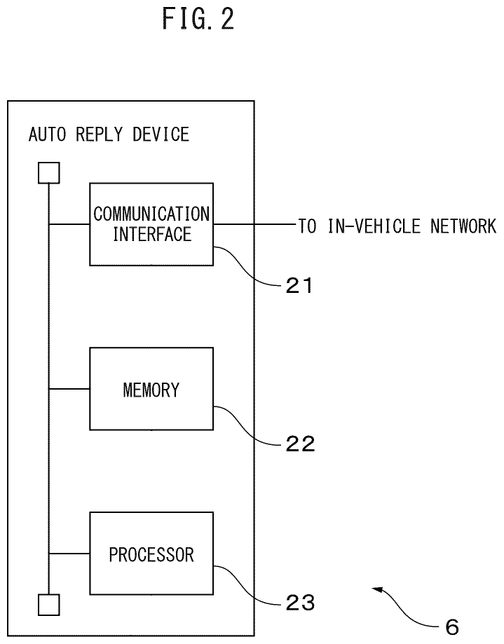

FIG. 2 illustrates the hardware configuration of the auto reply device 6. As illustrated in FIG. 2, the auto reply device 6 includes a communication interface 21, a memory 22, and a processor 23. The communication interface 21, the memory 22, and the processor 23 may be configured as separate circuits or a single integrated circuit.

The communication interface 21 includes an interface circuit for connecting the auto reply device 6 to another device inside the vehicle. The communication interface 21 passes an exterior image received from the exterior camera 2, an interior image received from the interior camera 3, and voice signals received from the individual microphones 4 to the processor 23. Further, the communication interface 21 outputs an answer signal received from the processor 23 to the notification device 5.

The memory 22, which is an example of a storage unit, includes, for example, volatile and nonvolatile semiconductor memories, and stores various types of data used in an auto reply process executed by the processor 23. More specifically, the memory 22 stores parameters specifying a classifier used for recognizing a predetermined object represented in an interior image or an exterior image and parameters specifying a generation model for generating an answer. For each of one or more registered persons who are pre-registered, the memory 22 further stores a feature vector representing features of the registered person (hereafter a “register vector”) and identifying information (e.g., the name, a nickname, or an identification number of the registered person). Further, the memory 22 may temporarily store exterior images received from the exterior camera 2, interior images received from the interior camera 3, and voice signals received from the individual microphones 4.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes an auto reply process.

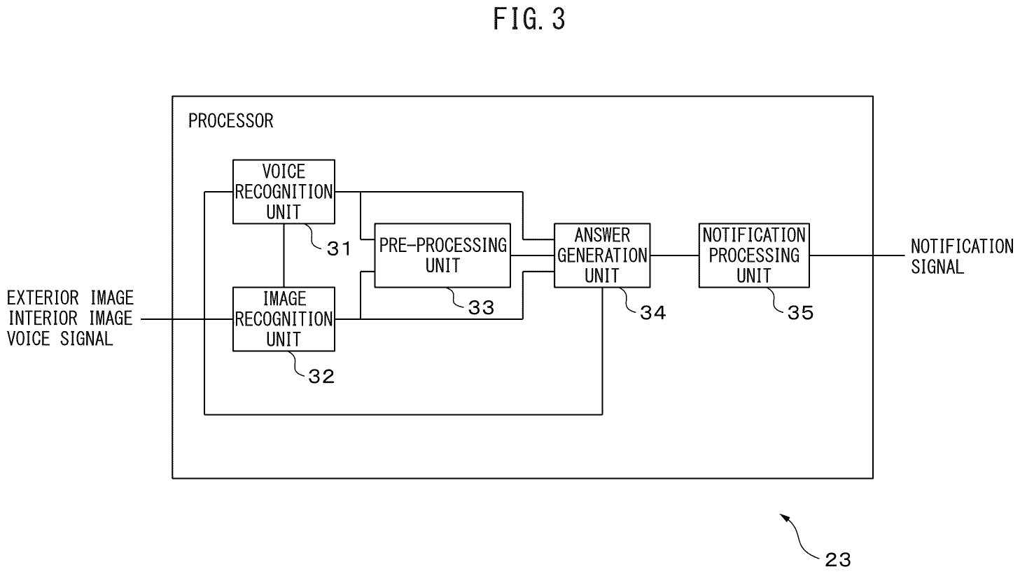

FIG. 3 is a functional block diagram of the processor 23, related to the auto reply process. The processor 23 includes a voice recognition unit 31, an image recognition unit 32, a pre-processing unit 33, an answer generation unit 34, and a notification processing unit 35. These units included in the processor 23 are, for example, functional modules implemented by a computer program executed by the processor 23, or may be dedicated operating circuits provided in the processor 23.

The voice recognition unit 31 recognizes a question asked by one of the occupants, based on a voice signal picked up by the microphone 4 and representing a voice in the vehicle interior. To achieve this, the voice recognition unit 31 inputs a voice signal into a voice recognition model, thereby recognizing a question represented in the voice signal. Such a voice recognition model is configured, for example, as a deep neural network (DNN) having an attention mechanism or a DNN having a recursive structure, such as a recurrent neural network (RNN). Alternatively, the voice recognition model may be configured as a GMM-HMM based on a mixture Gaussian distribution and a hidden Markov model or as a DNN-HMM based on a DNN and a hidden Markov model. The voice recognition model outputs a question represented in an inputted voice signal as text data. The voice recognition unit 31 may divide a voice signal into frames each having a predetermined length of time, extract a feature of the voice for each frame, and input the feature of each frame into the voice recognition model in chronological order, thereby recognizing a question represented in the voice signal. The feature of each frame may be, for example, a predetermined element of the cepstrum of the frame.

The voice recognition unit 31 outputs text data representing a question recognized from a voice signal to the image recognition unit 32, the pre-processing unit 33, and the answer generation unit 34.

The image recognition unit 32, which is an example of the recognition unit, recognizes at least one predetermined object that is represented in an exterior image or an interior image and that may be in question. A predetermined object that may be in question may be preset or a type of object mentioned in text data representing a question. Examples of a preset predetermined object include an occupant of the vehicle 1, a particular body part of an occupant, another vehicle traveling in an area around the vehicle 1, a pedestrian, and a particular structure such as a building and a signboard.

When an occupant of the vehicle 1 is recognized as a predetermined object, the image recognition unit 32 inputs an interior image into a classifier that has been trained to detect a region representing an occupant (hereafter a “human region”), thereby detecting a human region in the interior image. For each occupant in the interior of the vehicle 1, a human region representing the occupant is detected in this way. Such a classifier is configured as a DNN having architecture of a convolutional neural network (CNN) type, e.g., Single Shot MultiBox Detector, or a DNN having an attention mechanism, e.g., Vision transformer. Alternatively, such a classifier may be configured as a classifier based on a machine learning technique other than a DNN, e.g., an AdaBoost classifier.

Next, the image recognition unit 32 inputs the detected individual human regions into a feature extractor that has been trained to extract a feature vector representing features of an occupant represented in a human region, thereby extracting a feature vector from each human region. Such a feature extractor is configured, for example, as a DNN pre-trained by “unsupervised learning,” such as Auto-Encoder or Stacked What-Where Auto-Encoders. In this case, the feature extractor includes, in order from the input side, an encoder that outputs a feature having a lower dimension than inputted data (in the present embodiment, a human region) and a decoder into which the feature outputted from the encoder is inputted. The feature extractor is pre-trained with a large number of images representing various persons so that data outputted from the decoder is the same as data inputted into the encoder. By inputting a human region into a trained feature extractor, a feature vector representing features of an occupant represented in the human region is obtained as features outputted by the encoder. The feature extractor may be configured as a DNN trained by a technique such as self-supervised learning.

For each detected human region, the image recognition unit 32 calculates the degrees of matching (e.g., cosine similarities) of the feature vector extracted from the human region with respective register vectors of the registered persons who are pre-registered. The image recognition unit 32 then identifies the occupant represented in the human region as a registered person having a maximum degree of matching. When the maximum of the degrees of matching is less than a predetermined matching threshold, the image recognition unit 32 may determine that the occupant represented in the human region is not any of the registered persons.

For each detected human region, the image recognition unit 32 outputs positional information indicating the position and area of the human region in the image (e.g., the coordinates of the upper left and lower right corners of the human region) to the pre-processing unit 33. For each detected human region, the image recognition unit 32 may further output identifying information of the occupant represented in the human region to the answer generation unit 34. For an occupant different from any of the registered persons, the image recognition unit 32 outputs data meaning an unregistered person (e.g., text data “guest”) as identifying information of the occupant.

To recognize a predetermined object in an area around the vehicle 1, the image recognition unit 32 inputs an exterior image into a classifier that has been trained to detect such a predetermined object, thereby detecting an object region representing a predetermined object in the exterior image. The classifier may have the same configuration as the classifier used for detecting a human region.

When the text data representing a question includes a demonstrative, the image recognition unit 32 may estimate the posture of an occupant, based on a human region detected from an interior image. When the estimated posture is pointing in a particular direction, the image recognition unit 32 may determine an object in the particular direction as an object to be recognized. In the present embodiment, all the occupants in the vehicle 1 may be affected by an answer to a question asked by one of the occupants, and thus are examples of a person related to the question. For this reason, the occupant whose posture is to be estimated may differ from the occupant asking a question.

In this case, the image recognition unit 32 compares the text data representing a question with pre-registered demonstratives to determine whether the text data includes a demonstrative. When a demonstrative is included, the image recognition unit 32 inputs each human region detected from an interior image into a posture estimator to estimate the posture of the occupant represented in the human region. The posture estimator is configured, for example, as a posture estimation model that estimates a posture on the basis of a characteristic structure such as the skeleton of a human body. Such a posture estimation model may be, for example, a DNN having architecture of a CNN type.

When in the estimated posture of an occupant the left or right hand is shaped to point in a certain direction, the image recognition unit 32 determines that the posture of the occupant is pointing in a particular direction. The image recognition unit 32 determines whether the left or right hand is shaped to point in a certain direction, and determines a direction indicated by the hand in an exterior image, by template matching of the left or right hand in the estimated posture with templates representing the shape of a hand prepared for each direction of pointing. The image recognition unit 32 then estimates a direction indicated by the hand in the real space, based on the direction indicated by the hand in the interior image. Specifically, the image recognition unit 32 estimates a direction indicated by the hand in the real space, by referring to a table representing the relationship between a direction indicated by a hand in the real space and a direction indicated by a hand in an interior image. Such a table may be pre-stored in the memory 22. The image recognition unit 32 identifies a position corresponding to the direction identified in the exterior image, based on the estimated direction indicated by the hand as well as the mounted position, the angle of view, and the orientation of the exterior camera 2. The image recognition unit 32 then determines an object represented in an object region within a predetermined range of the identified position as an object to be recognized.

When the recognized object is a structure, the image recognition unit 32 may further identify the name of the structure represented in an object region by referring to map information. In this case, the image recognition unit 32 identifies a vector extending from the position of the vehicle 1 at the date and time of generation of an exterior image from which the predetermined object is detected (hereafter simply the “date and time of generation”) to the structure represented in the object region, based on the position and orientation of the vehicle 1 at the date and time of generation, the position of the object region in the exterior image, and parameters of the exterior camera 2 such as its orientation. The image recognition unit 32 then identifies a structure of the same type as the structure represented in the object region within a predetermined tolerance of the vector by referring to map information, and determines the name of the identified structure as that of the structure represented in the object region. The map information may be pre-stored in the memory 22.

For each detected object region, the image recognition unit 32 outputs positional information indicating the position and area of the object region in the image (e.g., the coordinates of the upper left and lower right corners of the object region) to the pre-processing unit 33. In addition, the image recognition unit 32 notifies the pre-processing unit 33 of an object pointed out by the posture of an occupant. For each detected object region, the image recognition unit 32 also outputs type information indicating the type of object represented in the object region to the answer generation unit 34. When the name of an object represented in a detected object region is identified, the image recognition unit 32 may further output the name of the object represented in the object region to the answer generation unit 34.

The pre-processing unit 33 pre-processes an exterior image or an interior image to extract a predetermined region in the exterior image or the interior image, depending on a question. An image obtained by pre-processing is inputted into a generation model that has been trained to generate an answer to a question (hereafter an “answer generation model”). Details of the answer generation model will be described below, together with the answer generation unit 34.

The pre-processing unit 33 refers to the text data representing a question received from the voice recognition unit 31 as well as the identifying information of the occupants represented in the interior image and the names of objects detected from the exterior image that are received from the image recognition unit 32. When the text data representing a question includes identifying information of an occupant, the pre-processing unit 33 determines that the human region representing the occupant identified by the identifying information included in the text data is a predetermined region to be extracted as input into the answer generation model. The pre-processing unit 33 then pre-processes the interior image to mask the region except the human region. Similarly, when the text data representing a question includes the name of an object detected from an exterior image, the pre-processing unit 33 determines that the object region representing the object identified by the name is a predetermined region to be extracted as input into the answer generation model. The pre-processing unit 33 then pre-processes the exterior image to mask the region except the object region.

This prevents image information on objects other than the object in question from being inputted into the answer generation model, enabling appropriate setting of a predetermined region to be extracted and facilitating generating an appropriate answer to the question. For example, when the question is “Is Mr. A sleeping?” the interior image is pre-processed to mask the image except the human region representing occupant A. When the text data representing a question includes identifying information or the names of multiple objects represented in the image, the pre-processing unit 33 pre-processes the interior image or the exterior image to mask the image except the human (object) regions corresponding to their identifying information or names.

When an object is pointed out by an occupant, the object region representing the object is supposed to be a region to which the occupant is paying attention. Thus the pre-processing unit 33 determines the object region representing the object pointed out by an occupant as a predetermined region to be inputted into the answer generation model. The pre-processing unit 33 then pre-processes the exterior image to mask the region except the object region. For example, when one of the occupants is pointing out a vehicle traveling ahead of the vehicle 1, the object region representing the vehicle ahead in an exterior image is a predetermined region to be extracted. In this case also, the predetermined region to be extracted is appropriately set, and image information on objects other than the object in question is prevented from being inputted into the answer generation model, facilitating generating an appropriate answer to the question.

When determining to mask the region except the human region representing a particular occupant, as described above, the pre-processing unit 33 crops only the human region from the interior image or substitutes the values of pixels other than the human region with a predetermined pixel value, thereby generating a pre-processed image that is masked except the human region. Similarly, when determining to mask the region except the object region representing a particular object, the pre-processing unit 33 crops only the object region from the exterior image or substitutes the values of pixels other than the object region with a predetermined pixel value, thereby generating a pre-processed image that is masked except the object region.

When the text data representing a question does not include identifying information of any of the occupants represented in an interior image or the name of any of the objects detected from an exterior image, the pre-processing unit 33 determines the entire interior image or the entire exterior image as a predetermined region to be extracted. In this case, the pre-processing unit 33 determines the entire interior image and the entire exterior image as a pre-processed image. This is because the question does not relate to a particular occupant or a particular object, and to generate an appropriate answer, it is probably required that the states of the individual occupants represented in the interior image or the entire exterior image can be referred to. For example, when the question is “Does everyone look hot?” the entire interior image is a predetermined region to be inputted into the answer generation model. In this way, when the text data representing a question does not include identifying information of any of the objects represented in the images, the entire interior image or the entire exterior image is set as a predetermined region, enabling appropriate setting of a predetermined region to be extracted.

The pre-processing unit 33 notifies the pre-processed image to the answer generation unit 34.

The answer generation unit 34 generates an answer to the question by inputting the image pre-processed by the pre-processing unit 33 and the question into the answer generation model.

In the present embodiment, the answer generation model is configured as a VLM. The VLM that is the answer generation model is configured, for example, as a combination of an image encoder that encodes an inputted pre-processed image and a large language model (LLM) with multiple stacked blocks each including an attention layer and a feed forward layer. The answer generation unit 34 inputs the pre-processed image into the image encoder and the text data representing a question into an input layer of the LLM.

When the predetermined region to be inputted into the answer generation model is the entire interior image or the entire exterior image, the answer generation unit 34 determines whether the text data representing a question includes a word related to the surroundings of the vehicle 1. When the text data representing a question includes a word related to the surroundings of the vehicle 1 (e.g., “pedestrian,” “vehicle ahead,” “rain,” or “traffic jam”), the answer generation unit 34 inputs the exterior image into the answer generation model. When the text data representing a question does not include a word related to the surroundings of the vehicle 1, the answer generation unit 34 inputs the interior image into the answer generation model. Words related to the surroundings of the vehicle 1 may be pre-stored in the memory 22. Alternatively, when the predetermined region to be inputted into the answer generation model is the entire interior image or the entire exterior image, the answer generation unit 34 may input an image obtained by arranging the interior image and the exterior image horizontally or vertically and joining them together into the answer generation model. The answer generation unit 34 may input an image obtained by further downsampling the joined image into the answer generation model.

The question inputted into the answer generation model may be independent of occupants recognized from an interior image and objects represented in an exterior image. In this case, the answer generation model is pre-trained to generate an answer to a question, independently of an inputted pre-processed image.

The answer generation unit 34 outputs text data representing the generated answer to the notification processing unit 35.

The notification processing unit 35 outputs the answer to the question via the notification device 5. For example, the notification processing unit 35 generates a voice signal representing the answer in accordance with a predetermined speech synthesis technique, based on the text data representing the answer received from the answer generation unit 34. The notification processing unit 35 then outputs the generated voice signal to the speaker included in the notification device 5, causing the speaker to output a voice representing the answer.

Alternatively, the notification processing unit 35 causes the text data representing the answer to appear on the display included in the notification device 5.

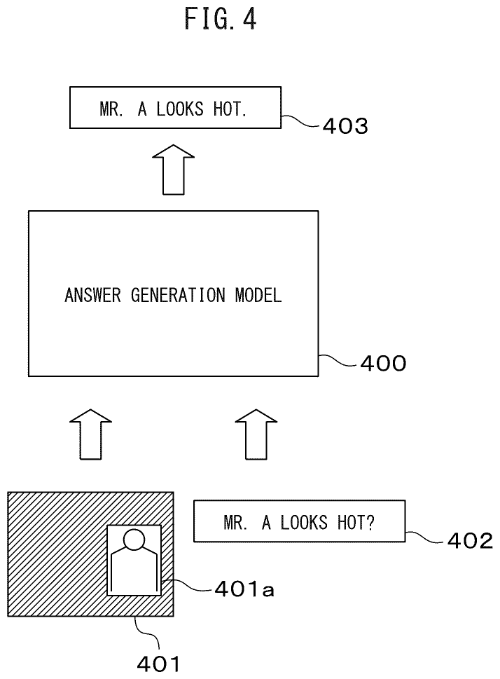

FIG. 4 is a diagram for explaining input and output of the answer generation model of the present embodiment. In the present embodiment, an image 401 pre-processed by the pre-processing unit 33 and text data 402 representing a question are inputted into an answer generation model 400. In this example, a human region 401a representing an occupant identified by identifying information “A” of the occupant included in the text data 402 is extracted by the pre-processed image 401 being masked except the human region 401a. The answer generation model 400 outputs text data 403 representing an answer to the question by referring to the inputted pre-processed image 401 and text data 402.

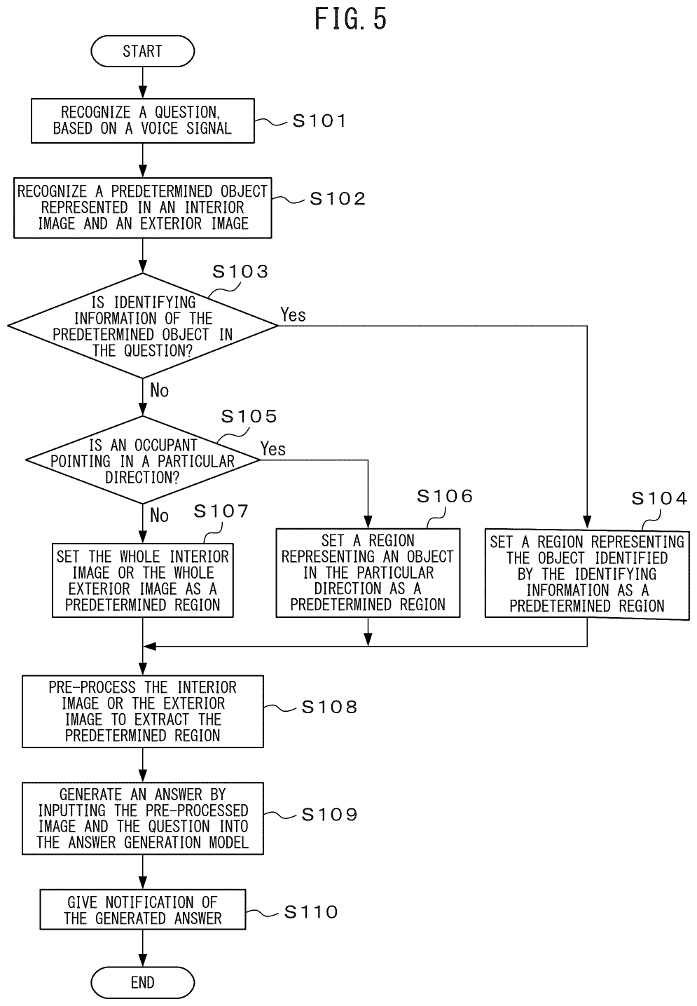

FIG. 5 is an operation flowchart of the auto reply process of the present embodiment. The processor 23 executes the auto reply process in accordance with the operation flowchart.

The voice recognition unit 31 recognizes a question asked by one of the occupants, based on a voice signal representing a voice inside the vehicle 1 (step S101). The image recognition unit 32 recognizes a predetermined object represented in an interior image and a predetermined object represented in an exterior image (step S102).

The pre-processing unit 33 determines whether the question includes identifying information of the predetermined object (step S103). When the identifying information is included (Yes in step S103), the pre-processing unit sets a region representing the predetermined object identified by the identifying information as a predetermined region to be extracted (step S104). When the identifying information is not included (No in step S103), the pre-processing unit 33 determines whether an occupant of the vehicle 1 is pointing in a particular direction (step S105). When an occupant is pointing in a particular direction (Yes in step S105), the pre-processing unit sets a region representing an object in the particular direction in the exterior image as a predetermined region to be extracted (step S106). When no occupant is pointing in a particular direction (No in step S105), the pre-processing unit 33 sets the entire interior image or the entire exterior image as a predetermined region (step S107).

After step S104, S106, or S107, the pre-processing unit 33 pre-processes the interior image or the exterior image to extract the predetermined region (step S108). The answer generation unit 34 generates an answer to the question by inputting the pre-processed image and the question into the answer generation model (step S109). The notification processing unit 35 notifies the generated answer to the occupant via the notification device 5 (step S110).

As has been described above, the auto reply device inputs a pre-processed image obtained by pre-processing an image to extract a predetermined region in the image, depending on a question, and the question into an answer generation model, thereby generating an answer to the question. The auto reply device automatically extracts a region representing an object related to a question among individual objects represented in an image to be inputted into the answer generation model, and can therefore generate an appropriate answer to the question with reduced man-hours.

According to a modified example, positional information indicating the positions of individual occupants recognized in an interior image may be inputted into the answer generation model, together with a pre-processed image and a question. Similarly, positional information indicating the position of an object detected in an exterior image may be inputted into the answer generation model, together with a pre-processed image and a question.

According to another modified example, the image to be inputted into the answer generation model may be limited to an image obtained by pre-processing an interior image (including the entire interior image) or an image obtained by pre-processing an exterior image (including the entire exterior image). In this case, the processing of the image recognition unit 32 and the pre-processing unit 33 on the former or latter image that is not used as input may be omitted.

According to still another modified example, the answer to the question may be used for executing control of the vehicle 1 or a device mounted on the vehicle 1. In this case, the answer generation model outputs text data representing details of control. The answer generation unit 34 determines a device to be controlled and a control command by referring to a reference table representing the correspondence between text data representing details of control, a device to be controlled (including the vehicle 1 itself), and a control command for executing this control. The answer generation unit 34 then outputs the determined control command to a control unit of the device to be controlled, via the communication interface 21.

The auto reply device is not limited to automotive embodiments and is usable in various systems capable of capturing a predetermined object that may be in question and required to generate an answer to a question about the predetermined object. For example, the auto reply device may be installed in a predetermined space within a facility and generate an answer to a question about one or more objects in the space. Further, the question may be inputted via a user interface that enables input of text data, such as a keyboard or a touch screen. In this case, the processing of the voice recognition unit 31 may be omitted.

The computer program for achieving the auto reply process of the above-described embodiment or modified examples may be provided in a form recorded on a computer-readable portable storage medium.

As described above, those skilled in the art may make various modifications according to embodiments within the scope of the present invention.

What is claimed is:

1. An auto reply device comprising:
a processor configured to:
pre-process an image to extract a predetermined region in the image, depending on a question, and
generate an answer to the question by inputting a pre-processed image and the question into a generation model that has been trained to generate the answer.

2. The auto reply device according to claim 1, wherein the processor is further configured to recognize at least one predetermined object represented in the image, wherein
when the question includes identifying information of one of the at least one predetermined object, the processor determines an object region representing an object identified by the identifying information among the at least one predetermined object in the image as the predetermined region.

3. The auto reply device according to claim 2, wherein when the question does not include identifying information of any of the at least one predetermined object, the processor determines the entire image as the predetermined region.

4. The auto reply device according to claim 2, wherein the processor identifies a region to which a person related to the question is paying attention in the image, based on the posture of the person, and determines the identified region as the predetermined region.

5. An auto reply method comprising:
pre-processing an image to extract a predetermined region in the image, depending on a question; and
generating an answer to the question by inputting a pre-processed image and the question into a generation model that has been trained to generate the answer.

6. A non-transitory recording medium that stores a computer program for auto reply, the computer program causing a computer to execute a process comprising:
pre-processing an image to extract a predetermined region in the image, depending on a question; and
generating an answer to the question by inputting a pre-processed image and the question into a generation model that has been trained to generate the answer.
